(19) United States
(12) Patent Application Publication
(10) Pub. No.: US 2021/0044366 A1
(43) Pub. Date: Feb. 11, 2021

(54) ESTIMATING STRENGTH OF RADIO FREQUENCY SIGNAL

(71) Applicant: Raytheon Company, Waltham, MA (US)

(72) Inventor: Mac Allen Cody, Richardson, TX (US)

(21) Appl. No.: 16/932,201

(22) Filed: Jul. 17, 2020

Related U.S. Application Data
(60) Provisional application No. 62/883,331, filed on Aug. 6, 2019.

(51) Int. Cl. H04B 17/391; H04B 17/318; G06T 17/20

(52) U.S. Cl. CPC H04B 17/3912; G06T 2210/56; G06T 17/20; H04B 17/318

(57) ABSTRACT

A system can identify, from a point cloud representing a scene, one or more scene elements, each with an element type, such as a building, a tree, or a parking lot. Each element type can have at least one associated electromagnetic propagation parameter, such as reflectivity, transmittivity, or absorptivity. A raytracing model can simulate electromagnetic radiation radiating from at least one electromagnetic radiation source positioned in the scene. The radiation can interact with a surface mesh representation of the scene elements. The system can calculate, from the simulation, a spatially-varying radiation level within the scene, and can augment the point cloud with data corresponding to the radiation level. The system can optionally display a visualization of the point cloud augmented with the radiation level data and can optionally display an indication of volumes in which the calculated radiation level falls below a threshold radiation level.

### CROSS-REFERENCE TO RELATED APPLICATION

This application claims the benefit of U.S. Provisional Application No. 62/883,331, filed Aug. 6, 2019, which is hereby incorporated by reference in its entirety.

### FIELD OF THE DISCLOSURE

The present disclosure relates generally to estimating a strength of a radio frequency (RF) signal.

### BACKGROUND OF THE DISCLOSURE

In some applications, such as tactical or military settings, ensuring that the wireless communication equipment remains reliable during operation can be important. For example, if a wireless communication device were to fail, such as due to a loss of signal, the failure could cut off communication between a person and the person's unit, which could potentially result in injury or death for the person.

To avoid such failure, there exists a need to estimate a signal strength for wireless devices, as a function of position. Such estimations can show locations at which the signal can be unsuitably weak. These locations can be communicated to personnel, so that the personnel can keep the wireless communication equipment away from these locations.

There is ongoing effort to improve the speed and robustness of such signal strength estimation.

### SUMMARY

Various aspects related to estimating strength of RF signals and generating RF propagation point cloud from imagery and/or other information are described. A system can identify, from a point cloud representing a scene, one or more scene elements, each with an element type, such as a building, a tree, or a parking lot. Each element type can have at least one associated electromagnetic propagation parameter, such as reflectivity, transmittivity, or absorptivity. A raytracing model can simulate electromagnetic radiation radiating from at least one electromagnetic radiation source positioned in the scene. The radiation can interact a surface mesh representation of the scene elements. The system can calculate, from the simulation, a spatially-varying radiation level within the scene, and can augment the point cloud with data corresponding to the radiation level. The system can optionally display a visualization of the point cloud augmented with the radiation level data and can optionally display an indication of volumes in which the calculated radiation level falls below a threshold radiation level.

### BRIEF DESCRIPTION OF THE DRAWINGS

FIG. 1 shows an example of a system that can estimate a strength of an RF signal, in accordance with some examples.

FIG. 2 shows an example of a visual representation of a point cloud of a scene, in accordance with some examples.

FIG. 3 shows an example of a visual representation of undefined scene elements that have been segmented from the point cloud of FIG. 2, in accordance with some examples.

FIG. 4 shows an example of a visual representation of roads and parking lots that have been segmented from the point cloud of FIG. 2, in accordance with some examples.

FIG. 5 shows an example of a visual representation of bare earth that has been segmented from the point cloud of FIG. 2, in accordance with some examples.

FIG. 6 shows an example of a visual representation of trees that have been segmented from the point cloud of FIG. 2, in accordance with some examples.

FIG. 7 shows an example of a visual representation of buildings that have been segmented from the point cloud of FIG. 2, in accordance with some examples.

FIG. 8 shows an example of a visual representation of elements that have been segmented from the point cloud of FIG. 2, in accordance with some examples.

FIG. 9 shows an example of a visual representation of a surface mesh using Poisson mesh reconstruction generated from the point cloud of FIG. 2, in accordance with some examples.

FIG. 10 shows an example of a completed surface mesh, in accordance with some examples.

FIG. 11 shows an example of a visual representation of a calculated spatially-varying radiation level arising from a radiating source located in a scene, superimposed with a mesh representation of the scene, in accordance with some examples.

FIG. 12 shows an example of a visual representation of the calculated spatially-varying radiation level and scene, from a lower elevation than shown in FIG. 11, in accordance with some examples.

FIG. 13 shows a flow chart of an example of a method that can estimate a strength of an RF signal, in accordance with some examples.

Corresponding reference characters indicate corresponding parts throughout the several views. Elements in the drawings are not necessarily drawn to scale. The configurations shown in the drawings are merely examples and should not be construed as limiting the scope of the invention in any manner.

### DETAILED DESCRIPTION

There are instances in which it is desirable to estimate a strength of a radio frequency (RF) signal. For example, in a military environment in which devices communicate wirelessly via RF radiation, it would be desirable to simulate a particular scene, determine if there are any “dead spots” in the scene at which the RF signal would be unacceptably low, and identify the location or locations of such “dead spots,” so that a system operator can instruct personnel to avoid the “dead spots” when moving through the scene. The simulation can use three-dimensional meshes generated from a point cloud to model elements (buildings, trees, water, pavement, and the like) in the scene. The positions of RF sources (RF transceivers, RF modems, wireless transceivers, wireless routers, Wi-Fi hot spots, and the like) can then be placed within the scene. The system can use raytracing to propagate an RF signal from the source or sources and simulate interaction of the RF radiation with elements in the scene. The system can calculate an energy density (or a similar physical quantity representing signal strength) at locations in the scene, can compare the calculated energy density to a threshold value, and can flag locations in the scene at which the calculated energy density is at or below the threshold value. The system can optionally display the flagged locations on a display. From viewing the display, a system operator can readily identify where in the scene the RF signal is unsuitably low. The system operator can then communicate the flagged locations to personnel, so that the personnel can avoid the flagged locations when moving through the scene.

In some examples, a system can identify, from a point cloud representing a scene, one or more scene elements, each with an element type, such as a building, a tree, a pond, or a parking lot. The system can create a surface mesh representation of the scene elements. Each element type can have at least one associated electromagnetic propagation parameter, such as reflectivity, transmittivity, or absorptivity. In some examples, one or more electromagnetic propagation parameters can be associated with the surface mesh representation of the scene elements. A raytracing model can simulate electromagnetic radiation radiating from at least one electromagnetic radiation source positioned in the scene. The radiation can interact with one or more of the scene elements. The system can calculate, from the simulation, a spatially-varying radiation level within the scene, and can augment the point cloud with data corresponding to the radiation level. The system can optionally display a visualization of the point cloud augmented with the radiation level data and can optionally augment the visualization to indicate volumes in which the calculated radiation level falls below a threshold radiation level.

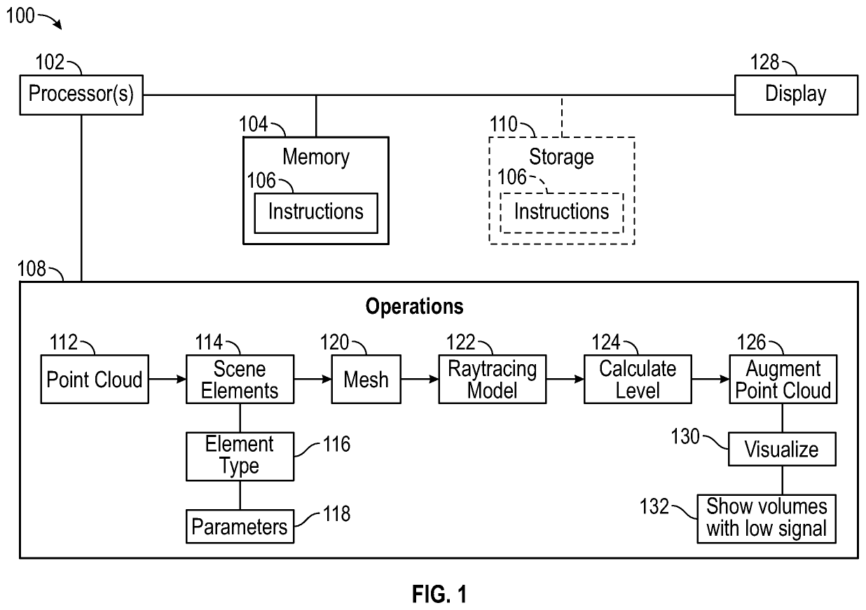

FIG. 1 shows an example of a system 100 that can estimate a strength of an RF signal, in accordance with some examples. The system 100 of FIG. 1 is but one example of a system that can estimate a strength of an RF signal; other suitable systems can also be used.

The system 100 can include at least one processor 102. The at least one processor 102 can perform any or all of image-processing tasks, point cloud-generating tasks, point cloud-processing tasks, point cloud-segmenting tasks, ray tracing tasks, or point cloud-augmenting tasks, among others. In some examples, the at least one processor 102 can include a single processor 102 that performs all of the above tasks. In other examples, the at least one processor 102 can include multiple processors 102, in a same location or optionally in different locations. For examples that use multiple processors 102, two processors 102 can perform two different tasks from those listed above.

The system 100 can include memory 104 coupled to the at least one processor 102. The memory 104 can store instructions 106 that, when executed the at least one processor 102, can cause the at least one processor 102 to perform particular operations 108 (discussed in detail below). In some examples, the system 100 can include a computer-readable storage medium 110 configured to store the instructions 106 that, when executed by the at least one processor 102, cause the at least one processor 102 to perform the particular operations 108.

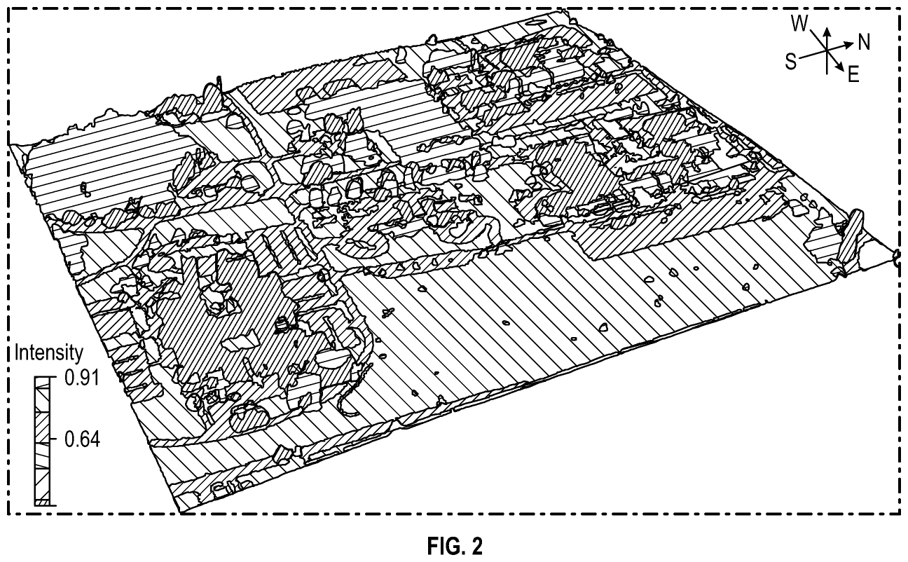

The operations 108 can include generating a three-dimensional point cloud 112 representing a scene. In a specific example, the scene can be a courtyard, including two buildings, four trees, a parking lot, a pond, and two Wi-Fi hot spots mounted on poles. The point cloud 112 can be a collection of three-dimensional locations that, taken together, can represent the surfaces and edges of the buildings, trees, and so forth. FIG. 2 shows an example of a visual representation of a point cloud of a scene, in accordance with some examples.

Returning to FIG. 1, three examples of techniques for generating the point cloud 112 are discussed below. The techniques can be used alone or in any combination. Other suitable techniques for generating the point cloud 112 can also be used. In a first example, generating the point cloud 112 can include using a beam of coherent light, via laser detector and ranging (LADAR) or light detection and ranging (LiDAR), to measure distances to elements in the scene. Both LADAR and LiDAR use time-of-flight measurements to determine distance. In a second example, generating the point cloud 112 can include using a radio-frequency emission, via synthetic aperture radar (SAR), to measure distances to elements in the scene. In a third example, the three-dimensional point cloud 112 representing the scene can be generated from two-dimensional imagery of the scene. The two-dimensional imagery can be obtained well in advance of the analysis, such as from satellite imagery, or obtained just prior to the analysis, such as from freshly-captured images. In these third examples, generating the point cloud 112 can include using multiple optical images, via photogrammetric extraction, to perform multi-image matching of comparable points in two or more images of the multiple optical images.

The operations 108 can further include identifying, from the point cloud 112, one or more scene elements 114. In the specific example of the courtyard, the scene elements 114 can include the two buildings, the four trees, the parking lot, the pond, and the two Wi-Fi hot spots. For this example, the system 100 can recognize spectral and/or spatial patterns in the point cloud 112, and identify the recognized patterns as being the buildings, the trees, and so forth.

In some examples, identifying each scene element 114 from the point cloud 112 can include segmenting the point cloud 112 into a plurality of scene elements 114, where the plurality of scene elements 114 fully represents all the elements identified in the point cloud 112. Specifically, in some examples, the point cloud 112 can be segmented into scene elements 114, and the scene elements 114 (rather than the point cloud 112) can be used downstream for a subsequent raytracing step. For examples in which the point cloud 112 is segmented into scene elements 114, the scene elements 114 can represent some or all of the elements that interact with electromagnetic radiation in a subsequent raytracing step. In the specific example of the courtyard, the two buildings, the four trees, the parking lot, and the pond, can form the full collection of elements that interact with electromagnetic radiation produced by the Wi-Fi hot spots in a subsequent raytracing step. Alternatively, one or more unidentified features in the point cloud 112 can also remain to interact with the electromagnetic radiation in the subsequent raytracing step.

Each scene element 114 can have a corresponding element type 116 selected from a plurality of element types 116. In some examples, the plurality of element types 116 can include at least one of a building, a tree, bare earth, low-lying vegetation, a sidewalk, a road, a parking lot, water, or a miscellaneous man-made structure. To perform the selection, the operations 108 can detect a spectral and/or a spatial pattern in the point cloud 112, can compare the detected pattern to a collection of pre-identified patterns (e.g., a pattern of a generic building, a pattern of a generic tree, and so forth), and can select the pre-identified pattern that most closely matches the detected pattern.

Three examples of techniques for identifying scene elements 114 from the point cloud 112 are provided; the techniques can be used alone or in any combination, and other suitable techniques for identifying the scene elements 114 can also be used. In a first example, identifying each scene element 114 from the point cloud 112 can include determining a spectral content of each data point in the scene and matching the determined spectral content to one of a specified plurality of spectral signatures. In a second example, identifying each scene element 114 from the point cloud 112 can include determining heights of data points in the scene above a baseline height and matching the determined heights to one of a specified plurality of object height patterns. In a third example, identifying each scene element 114 from the point cloud 112 can include generating the point cloud 112 representing the scene from two-dimensional imagery of the scene, the two-dimensional imagery including a two-dimensional multispectral image of an overhead view of the scene.

The operations 108 can further include assigning to each scene element 114, based on the corresponding element type 116, at least one electromagnetic propagation parameter 118 that is configured to quantify how the scene element 114 interacts with electromagnetic radiation. In some examples, the at least one electromagnetic propagation parameter 118 can include at least one of a reflectivity, a transmittivity, an absorptivity, a frequency-dependent value of reflectivity, a frequency-dependent value of transmittivity, or a frequency-dependent value of absorptivity. In the specific example of the courtyard, the buildings can be assigned electromagnetic parameters 118 that describe how much radiation reflects from a (generic) building, how much radiation transmits through a (generic) building, and how much radiation absorbs into a (generic) building. Similarly, the trees can be assigned electromagnetic parameters 118 that describe how much radiation reflects from a (generic) tree, how much radiation transmits through a (generic) tree, and how much radiation absorbs into a (generic) tree. In this example, the generic building and the generic tree are element types 116, which have been selected from the plurality of element types 116.

Optionally, one or more of the scene elements 114 can include multiple sets of electromagnetic propagation parameters 118, which can describe different parts of the scene element 114. For example, a particular building can be formed from bricks and glass, and the building can be assigned one set of parameters 118 that describe radiation interaction with (generic) bricks and can be assigned another set of parameters 118 that describe radiation interaction with (generic) glass. Similarly, a particular tree can be assigned one set of parameters 118 that describe radiation interaction with a (generic) trunk and can be assigned another set of parameters 118 that describe radiation interaction with (generic) leaves. For these examples, the scene elements 114 can be further decomposed into subelements, with each subelement having a particular location in the scene (or on the scene element 114) and having its own set of electromagnetic propagation parameters 118.

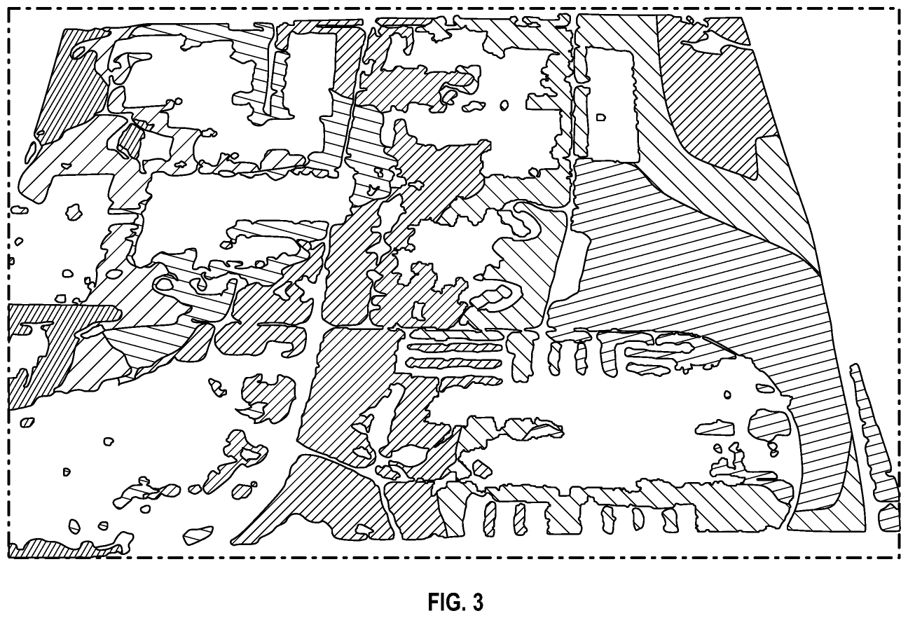

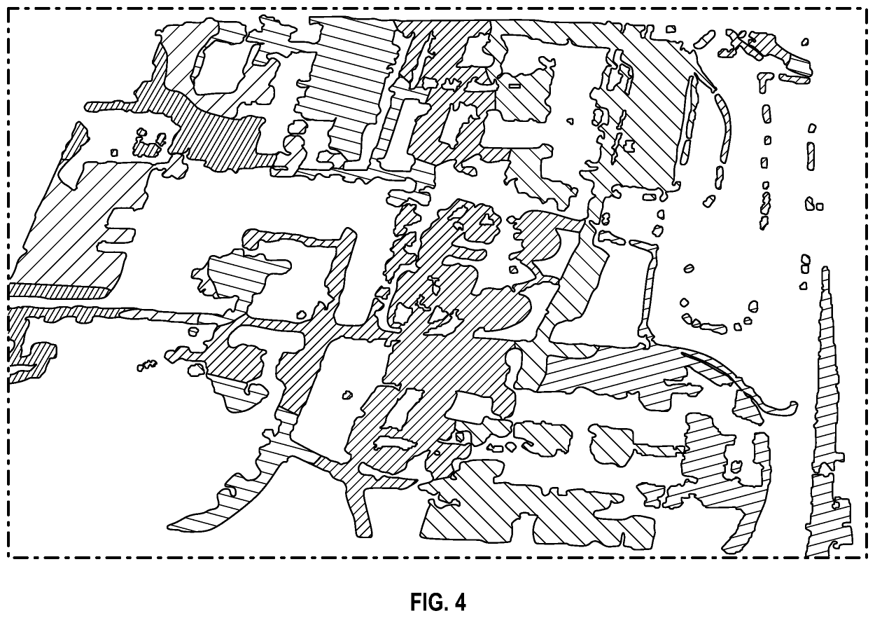

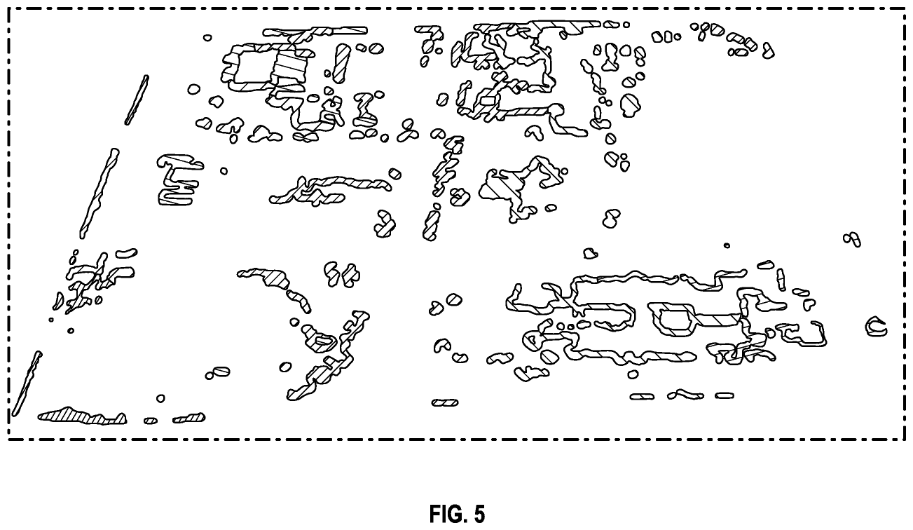

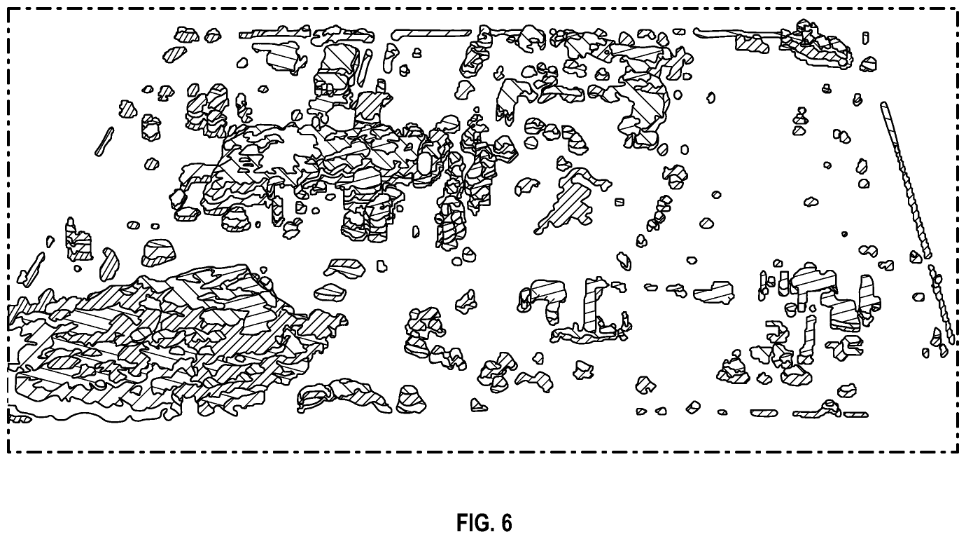

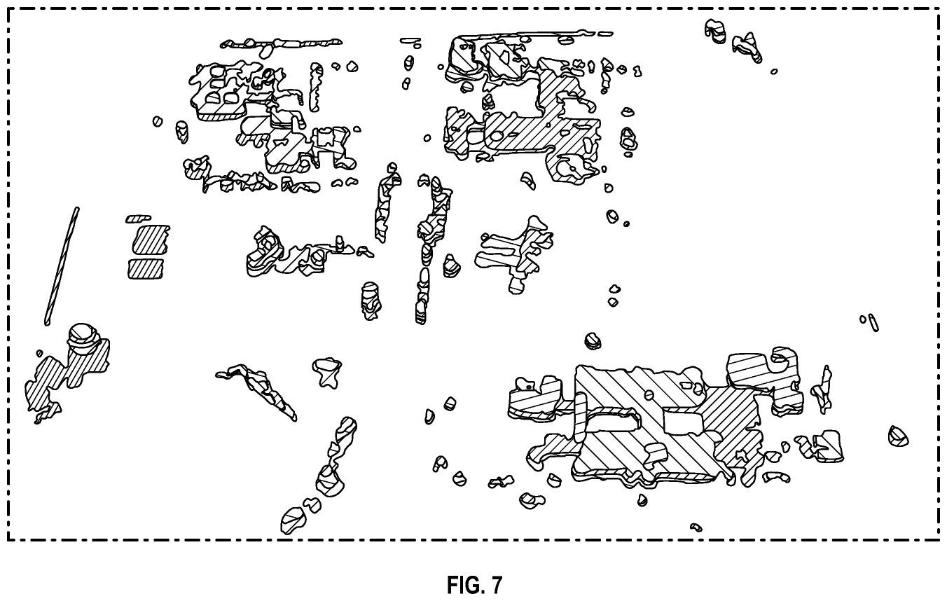

FIGS. 3-7 show examples of visual representations of scene elements that have been segmented from the point cloud of FIG. 2, in accordance with some examples. FIG. 3 shows an example of a visual representation of undefined scene elements that have been segmented from the point cloud of FIG. 2, in accordance with some examples. FIG. 4 shows an example of a visual representation of roads and parking lots that have been segmented from the point cloud of FIG. 2, in accordance with some examples. FIG. 5 shows an example of a visual representation of bare earth that has been segmented from the point cloud of FIG. 2, in accordance with some examples. FIG. 6 shows an example of a visual representation of trees that have been segmented from the point cloud of FIG. 2, in accordance with some examples. FIG. 7 shows an example of a visual representation of buildings that have been segmented from the point cloud of FIG. 2, in accordance with some examples. The examples of FIGS. 3-7 are but mere examples of results of segmenting; other suitable examples can also be used.

Returning again to FIG. 1, the operations 108 can further include creating a surface mesh representation 120 of the scene elements 114.

The operations 108 can further include using a raytracing model 122 to simulate electromagnetic radiation radiating from at least one electromagnetic radiation source positioned in the scene. The raytracing model 122 can incorporate data from the surface mesh representation 120 and can include data corresponding to each electromagnetic radiation source in the scene. Tracing the rays can optionally include at least one interaction with at least one scene element 114. In some examples, using the raytracing model 122 to simulate electromagnetic radiation can include tracing rays, using the raytracing model 122, that propagate away from the at least one electromagnetic radiation source, such that at least some of the rays interact with the surface mesh representation of the scene.

Each ray is traced in a line of sight away from an electromagnetic radiation source in the scene. As the ray propagates, the system 100 can simulate an energy density (or an equivalent physical quantity that can represent signal strength, such as power density, energy, or power) at locations along the ray. The energy density can fall off with distance in a known manner from the radiation source. For example, for sources that radiate like point sources, the falloff can be proportional to one divided by distance squared, the distance being a distance from the point source to the observation point along the traced ray. For directional sources, such as dipole radiators or directional radiators, the falloff can be more complicated mathematically, but can be handled readily by the raytracing.

Each ray can be traced until it strikes one of the scene elements 114. The electromagnetic propagation parameters 118 describe how the energy density changes upon interaction with the scene element 114. For example, if a reflectivity of a particular surface is 70%, then a ray reflecting from the surface has its associated energy density multiplied by 0.7 after the reflection, compared to the energy density before the reflection.

Data from the raytracing can be compiled in a statistical manner, such as a Monte Carlo analysis. Performing such statistical analysis can produce results with relatively small number of rays, so that the full signal strength analysis may be performed relatively quickly.

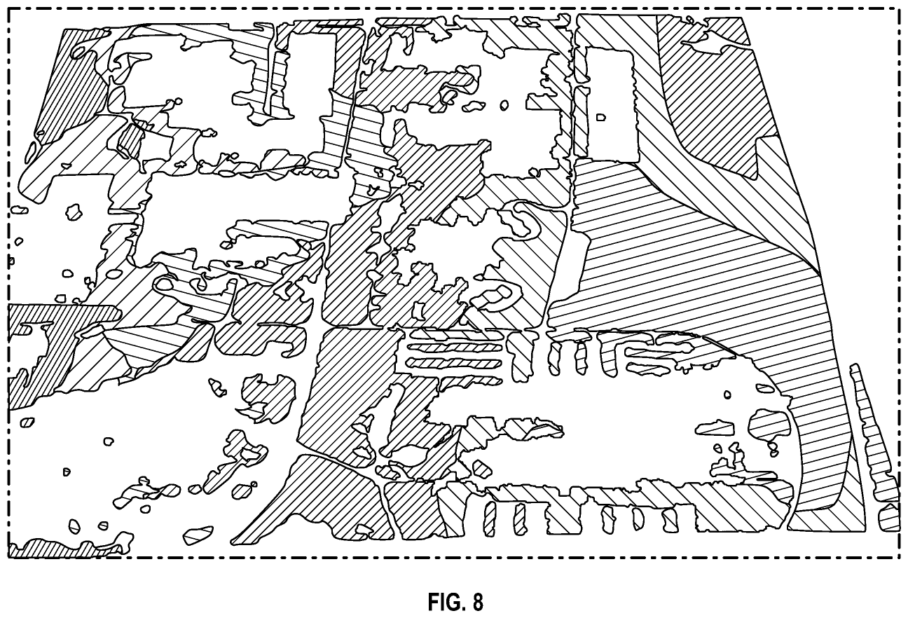

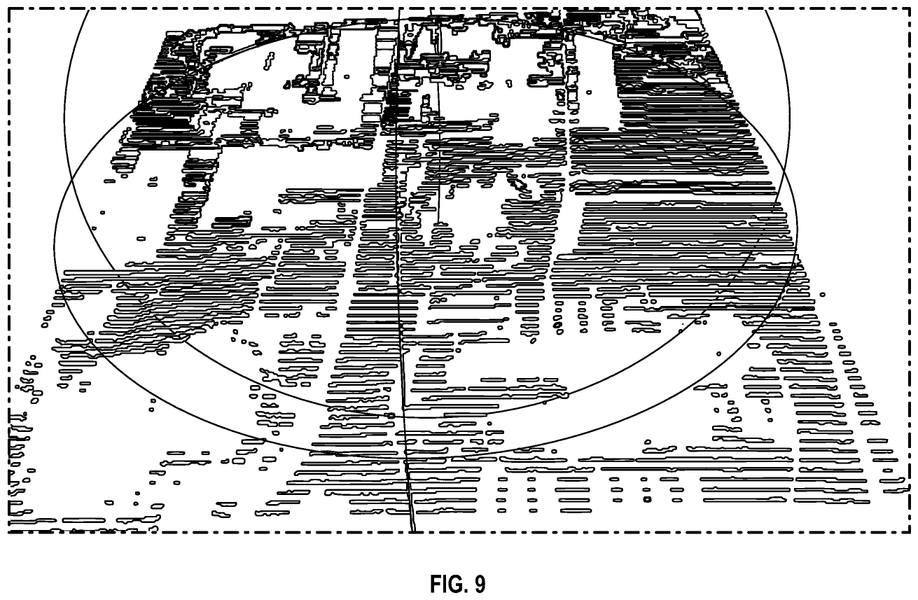

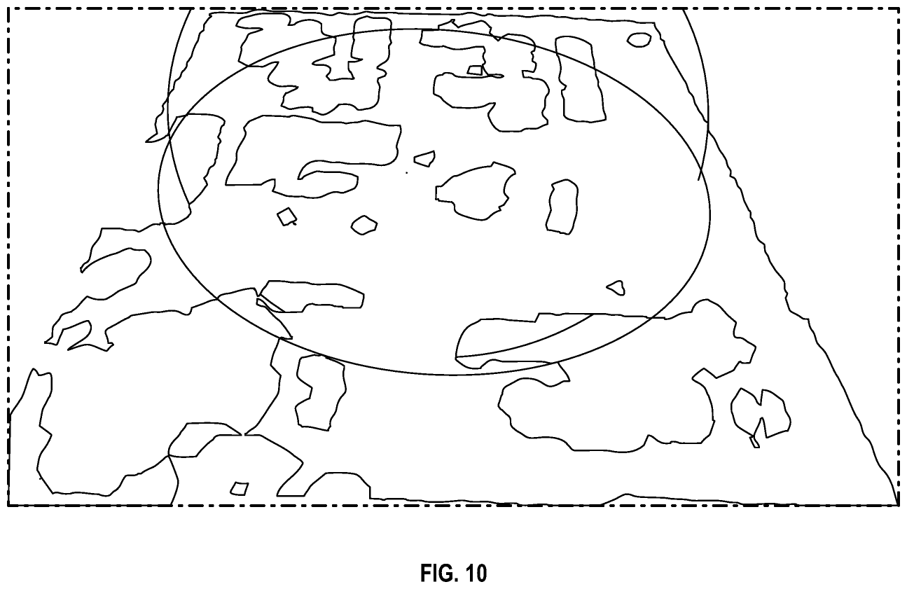

FIGS. 8-10 show examples of visual representations of intermediate quantities that can be used to generate a surface mesh, in accordance with some examples. FIG. 8 shows an example of a visual representation of elements that have been segmented from the point cloud of FIG. 2, in accordance with some examples. In the example of FIG. 8, the elements correspond to the undefined scene elements shown in FIG. 3. Other examples can also be used. FIG. 9 shows an example of a visual representation of a surface mesh using Poisson mesh reconstruction generated from the point cloud of FIG. 2, in accordance with some examples. Poisson mesh reconstruction is one approach to surface mesh generation; other suitable approaches can include Delaunay, Octree/Quadtree, and Advancing Front. FIG. 10 shows an example of a completed surface mesh, in accordance with some examples. In the example of FIG. 10, the surface mesh has been formed by combining information from the surface mesh of FIG. 9 with the undefined scene elements of FIG. 8. The examples of FIGS. 8-10 are but mere examples of results of a surface mesh and intermediate quantities used to form the surface mesh; other suitable examples can also be used.

Returning again to FIG. 1, the operations 108 can further include calculating, from the simulation, a spatially-varying radiation level 124 within the scene. In some examples, calculating, from the simulation, the spatially-varying radiation level 124 within the scene can include calculating, for each volume element in the raytracing model 122, a value of one of electromagnetic power, electromagnetic energy, electromagnetic power density, or electromagnetic energy density.

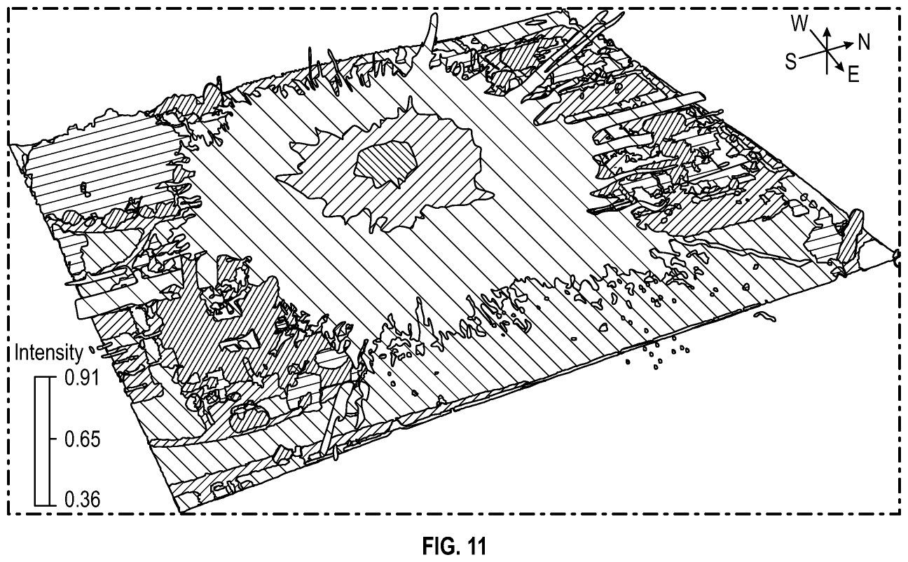

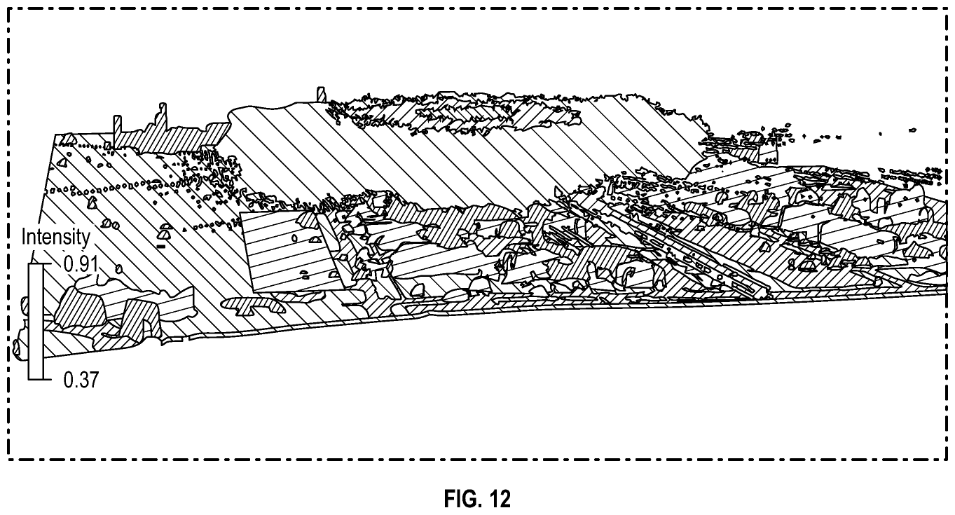

FIG. 11 shows an example of a visual representation of a calculated spatially-varying radiation level arising from a radiating source located in a scene, superimposed with a mesh representation of the scene, in accordance with some examples. In FIG. 11, the radiating source is an isotropic radiator; other sutiable radiation patterns can also be used. FIG. 12 shows an example of a visual representation of the calculated spatially-varying radiation level and scene, from a lower elevation than shown in FIG. 11, in accordance with some examples. The examples of FIGS. 11 and 12 are but mere examples of calculated spatially-varying radiation levels; other suitable examples and other suitable outputs can also be used.

Returning again to FIG. 1, the operations 108 can further include augmenting 126 the point cloud 112 with data corresponding to the calculated spatially-varying radiation level 124. In some examples, augmenting 126 the point cloud 112 with data corresponding to the calculated spatially-varying radiation level 124 can include storing the data in a data store. Examples of suitable data stores can include one or more of a file stored locally on a device, a file stored remotely on a server and accessible on the server, storage in memory 104, storage on a storage device, and so others.

The system 100 can further include a display 128 coupled to the at least one processor 102. The operations 108 can further include displaying, on the display 128, a visualization 130 of the point cloud 112 augmented with data corresponding to the calculated radiation level 124. For example, the visualization 130 can include a visualization of the scene elements 114 in the scene and can optionally include data corresponding to the simulated radiation signal strength superimposed on, in, and/or between the scene elements 114. The data can include color coding for particular regions in the scene and/or numerical values displayed on the display 128.

The operations 108 can further include displaying, on the display 128, an indication 132 of volumes in which the calculated radiation level 124 falls below a threshold radiation level. For example, the indication 132 can include a specified color for volumes in which the calculated radiation level 124 falls below a threshold radiation level. In the specific example of the courtyard, in which the simulation has predicted an unacceptably low signal strength between the two buildings, the visualization can color the low signal strength volumes red. Other coloring or visualization schemes can also be used.

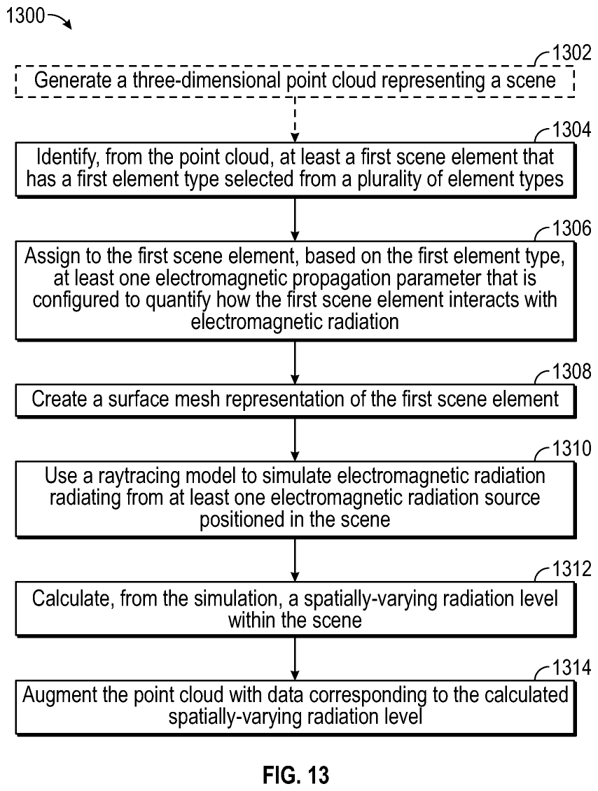

FIG. 13 shows a flow chart of an example of a method that can estimate a strength of an RF signal, in accordance with some examples. The method of FIG. 13 can be executed on the system 100 of FIG. 1, or on other suitable systems. The method of FIG. 13 is but one example of a method that can estimate a strength of an RF signal; other suitable methods can also be used.

At operation 1302, the system may optionally generate a three-dimensional point cloud representing a scene. In some other embodiments, the system may simply use an existing three-dimensional point cloud of a scene of interest in the processes described herein.

At operation 1304, the system can identify, from the point cloud, at least a first scene element that has a first element type selected from a plurality of element types.

At operation 1306, the system can assign to the first scene element, based on the first element type, at least one electromagnetic propagation parameter that is configured to quantify how the first scene element interacts with electromagnetic radiation.

At operation 1308, the system can create a surface mesh representation of the plurality of scene elements.

At operation 1310, the system can use a raytracing model to simulate electromagnetic radiation radiating from at least one electromagnetic radiation source positioned in the scene. The raytracing model can incorporate data from the surface mesh representation and the at least one electromagnetic radiation source. The radiating can include at least one interaction with the first scene element. In some examples, the scene elements can be converted to surface meshes. In some examples, all the surface meshes can be present for operation 1310. In some examples, operation 1310 can be performed with the surface meshes for all element types simultaneously. In some examples, the at least one electromagnetic propagation parameter can be associated with the surface mesh from operation 1308. In some examples, the at least one electromagnetic propagation parameter can be carried through when the segmented point clouds are converted to surface meshes.

At operation 1312, the system can calculate, from the simulation, a spatially-varying radiation level within the scene.

At operation 1314, the system can augment the point cloud with data corresponding to the calculated spatially-varying radiation level.

The method 1300 can optionally further include displaying a visualization of the point cloud augmented with the data corresponding to the calculated radiation level.

The method 1300 can optionally further include displaying an indication of volumes in which the calculated radiation level falls below a threshold radiation level.

Although the inventive concept has been described in detail for the purpose of illustration based on various embodiments, it is to be understood that such detail is solely for that purpose and that the inventive concept is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

Furthermore, since numerous modifications and changes will readily occur to those with skill in the art, it is not desired to limit the inventive concept to the exact construction and operation described herein. Accordingly, all suitable modifications and equivalents should be considered as falling within the spirit and scope of the present disclosure.

### STATEMENT OF INDUSTRIAL APPLICABILITY

This disclosure has application in signal strength estimation, particularly in estimating a strength of an RF signal.

It is instructive to consider several examples of applications for which the present system can be used.

A first example can include planning a 5G field network, such as for a warfighter. One possible goal of 5G planning can be to cover as much of the earth's area as possible with 5G signals. For regions involved in military conflict, it can be difficult or impossible to perform site surveys. Using the systems and/or methods described in detail herein can allow overhead imagery to generate three-dimensional scene models. For example, the systems and/or methods described in detail herein can perform RF ray tracing within a three-dimensional scene model to analyze a scene, simulate signal propagation within the scene, and estimate signal strength at locations within the scene.

A second example can include applications that pertain to electronic warfare. For example, the systems and/or methods described in detail herein can provide mission support, such as to ensure that a person can remain in communication as the person moves within a scene.

A third example can provide counterforce signal exploitation and/or jamming. For example, the systems and/or methods described in detail herein can help analyze an enemy's signals and can help determine locations at which to place signal jammers.

A fourth example can help determine where to place transmitters to avoid detection by a counter force's direction-finding equipment. For example, the systems and/or methods described in detail herein can run multiple simulations, with a transmitter being located at a different transmitter location in each simulation. The simulations can analyze signal strength at one or more counter force's direction-finding equipment locations. The simulations can produce a map of suitable locations at which the transmitters can be placed, with specified levels of risk of detection by the counter force's direction-finding equipment. For example, simulations that place the transmitter at different locations can yield a map that indicates where detection is probable, possible, or unlikely.

A fifth example can include warfighter training. For example, the systems and/or methods described in detail herein can provide inputs for communications environment emulation for augmented reality training exercises and/or virtual reality training exercises.

A sixth example can include determining suitable transmitter locations for an urban environment, such a location with relatively tall buildings. For example, the systems and/or methods described in detail herein can run multiple simulations to test various transmitter locations, to ensure that there is suitable signal strength at various locations within or on the tall buildings. Such simulation can help plan a 5G network, such as for peacetime in a city. Using the systems and/or methods described in detail herein can use remote sensing, such as imaging obtained from satellites and/or aircraft, to provide input to the raytracing, which can be less expensive and/or simpler than obtaining similar input via ground-based techniques.

A seventh example can include assisting with persistent close air support for aircraft. For example, the systems and/or methods described in detail herein can help connect ground-based controllers with overhead aircraft, such as to coordinate friendly-force identification, to perform target correlation, and/or to spot hostile forces with relative precision.

Other applications are also contemplated.

### EXAMPLES

To further illustrate the device and related method disclosed herein, a non-limiting list of examples is provided below. Each of the following non-limiting examples can stand on its own or can be combined in any permutation or combination with any one or more of the other examples.

In Example 1, a system can include: at least one processor; memory coupled to the at least one processor, the memory configured to store instructions that, when executed by the at least one processor, cause the at least one processor to execute operations, the operations comprising: generating a three-dimensional point cloud representing a scene; identifying, from the point cloud, at least a first scene element that has a first element type selected from a plurality of element types; assigning to the first scene element, based on the first element type, at least one electromagnetic propagation parameter that is configured to quantify how the first scene element interacts with electromagnetic radiation; creating a surface mesh representation of the first scene element; using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with the first scene element; calculating, from the simulation, a spatially-varying radiation level within the scene; and augmenting the point cloud with data corresponding to the calculated spatially-varying radiation level.

In Example 2, the system of Example 1 can optionally further include a display coupled to the at least one processor, wherein the operations further comprise displaying, on the display, a visualization of the point cloud augmented with the data corresponding to the calculated radiation level.

In Example 3, the system of any one of Examples 1-2 can optionally be configured such that the operations further comprise displaying, on the display, an indication of volumes in which the calculated radiation level falls below a threshold radiation level.

In Example 4, the system of any one of Examples 1-3 can optionally be configured such that generating the three-dimensional point cloud comprises at least one of: using a beam of coherent light, via laser detector and ranging (LADAR) or light detection and ranging (LiDAR), to measure distances to elements in the scene, the elements including the first scene element; using a radio-frequency emission, via synthetic aperture radar (SAR), to measure distances to elements in the scene, the elements including the first scene element; or using multiple optical images, via photogrammetric extraction, to perform multi-image matching of comparable points in two or more images of the multiple optical images.

In Example 5, the system of any one of Examples 1-4 can optionally be configured such that identifying, from the point cloud, at least the first scene element comprises at least one of: determining a spectral content of each data point in the scene and matching the determined spectral content to one of a specified plurality of spectral signatures; determining heights of data points in the scene above a baseline height and matching the determined heights to one of a specified plurality of object height patterns; or generating the point cloud representing the scene from two-dimensional imagery of the scene, the two-dimensional imagery including a two-dimensional multispectral image of an overhead view of the scene.

In Example 6, the system of any one of Examples 1-5 can optionally be configured such that the at least one electromagnetic propagation parameter comprises at least one of a reflectivity, a transmittivity, an absorptivity, a frequency-dependent value of reflectivity, a frequency-dependent value of transmittivity, or a frequency-dependent value of absorptivity.

In Example 7, the system of any one of Examples 1-6 can optionally be configured such that the plurality of element types includes at least one of a building, a tree, bare earth, low-lying vegetation, a sidewalk, a road, a parking lot, water, or a miscellaneous man-made structure.

In Example 8, the system of any one of Examples 1-7 can optionally be configured such that: a first element type of the plurality of element types is a building formed from at least a first building material and a second building material; and the at least one electromagnetic propagation parameter corresponding to the building includes at least one first value corresponding to a first building material, and at least one second value corresponding to a second building material different from the first building material.

In Example 9, the system of any one of Examples 1-8 can optionally be configured such that using the raytracing model to simulate electromagnetic radiation comprises: incorporating the surface mesh representation into the raytracing model; and tracing rays, using the raytracing model, that propagate away from the at least one electromagnetic radiation source, such that at least some of the rays interact with the surface mesh representation of the first scene element.

In Example 10, the system of any one of Examples 1-9 can optionally be configured such that the operations further comprise: segmenting the point cloud into a plurality of scene elements, the plurality of scene elements including the first scene element, the plurality of scene elements fully representing all the elements identified in the point cloud; assigning at least one electromagnetic propagation parameter to each scene element; creating a surface mesh representation of the plurality of scene elements; incorporating the surface mesh representation into the raytracing model; and tracing rays, using the raytracing model, that propagate away from the at least one electromagnetic radiation source, such that at least some of the rays interact with the surface mesh representation of the plurality of scene elements.

In Example 11, the system of any one of Examples 1-10 can optionally be configured such that calculating the spatially-varying radiation level within the scene comprises calculating, for each volume element in the raytracing model, a value of one of electromagnetic power, electromagnetic energy, electromagnetic power density, or electromagnetic energy density.

In Example 12, the system of any one of Examples 1-11 can optionally be configured such that augmenting the point cloud with data corresponding to the calculated spatially-varying radiation level comprises storing the data in a data store.

In Example 13, a method can include: generating a three-dimensional point cloud representing a scene; identifying, from the point cloud, at least a first scene element that has a first element type selected from a plurality of element types; assigning to the first scene element, based on the first element type, at least one electromagnetic propagation parameter that is configured to quantify how the first scene element interacts with electromagnetic radiation; creating a surface mesh representation of the first scene element; using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with the first scene element; calculating, from the simulation, a spatially-varying radiation level within the scene; and augmenting the point cloud with data corresponding to the calculated spatially-varying radiation level.

In Example 14, the method of Example 13 can optionally further include displaying a visualization of the point cloud augmented with the data corresponding to the calculated radiation level.

In Example 15, the method of any one of Examples 13-14 can optionally further include displaying an indication of volumes in which the calculated radiation level falls below a threshold radiation level.

In Example 16, a system can include: at least one processor; memory coupled to the at least one processor, the memory configured to store instructions that, when executed by the at least one processor, cause the at least one processor to execute operations, the operations comprising: generating, from two-dimensional imagery of a scene, a three-dimensional point cloud representing the scene; identifying, from the point cloud, a plurality of scene elements, each of the plurality of scene elements having a respective element type selected from a plurality of element types; assigning to each of the plurality of scene elements, based on the respective element type, at least one electromagnetic propagation parameter that is configured to quantify how the respective scene element interacts with electromagnetic radiation; creating a surface mesh representation of the plurality of scene elements; using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with at some of the plurality of scene elements; calculating, from the simulation, a spatially-varying radiation level within the scene; and augmenting the point cloud with data corresponding to the calculated spatially-varying radiation level.

In Example 17, the system of Example 16 can optionally be configured such that identifying the plurality of scene elements comprises: segmenting the point cloud into a plurality of scene elements, the plurality of scene elements including the first scene element, the plurality of scene elements fully representing all the elements identified in the point cloud.

In Example 18, the system of any one of Examples 16-17 can optionally be configured such that the raytracing model to simulate electromagnetic radiation comprises: incorporating the surface mesh representation into the raytracing model; and tracing rays, using the raytracing model, that propagate away from the at least one electromagnetic radiation source, such that at least some of the rays interact with the surface mesh representation of the plurality of scene elements.

In Example 19, the system of any one of Examples 16-18 can optionally further include a display coupled to the at least one processor, wherein the operations further comprise displaying, on the display, a visualization of the point cloud augmented with the data corresponding to the calculated radiation level.

In Example 20, the system of any one of Examples 16-19 can optionally be configured such that the operations further comprise displaying, on the display, an indication of volumes in which the calculated radiation level falls below a threshold radiation level.

What is claimed is:

1. A system, comprising:
at least one processor;
memory coupled to the at least one processor, the memory configured to store instructions that, when executed by the at least one processor, cause the at least one processor to perform operations, the operations comprising:
identifying, from a three-dimensional point cloud representing a scene, at least a first scene element that has a first element type selected from a plurality of element types;
assigning to the first scene element, based on the first element type, at least one electromagnetic propagation parameter that is configured to quantify how the first scene element interacts with electromagnetic radiation;
creating a surface mesh representation of the first scene element;
using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with the first scene element;
calculating, from the simulation, a spatially-varying radiation level within the scene; and
augmenting the point cloud with data corresponding to the calculated spatially-varying radiation level.

2. The system of claim 1, further comprising a display coupled to the at least one processor, wherein the operations further comprise displaying, on the display, a visualization of the point cloud augmented with the data corresponding to the calculated radiation level.

3. The system of claim 2, wherein the operations further comprise displaying, on the display, an indication of volumes in which the calculated radiation level falls below a threshold radiation level.

4. The system of claim 1, wherein the operations further comprise generating the three-dimensional point cloud of the scene based on at least one of:
using a beam of coherent light, via laser detector and ranging (LADAR) or light detection and ranging (LiDAR), to measure distances to elements in the scene, the elements including the first scene element;
using a radio-frequency emission, via synthetic aperture radar (SAR), to measure distances to elements in the scene, the elements including the first scene element; or
using multiple optical images, via photogrammetric extraction, to perform multi-image matching of comparable points in two or more images of the multiple optical images.

5. The system of claim 1, wherein identifying, from the point cloud, at least the first scene element comprises at least one of:
determining a spectral content of each data point in the scene and matching the determined spectral content to one of a specified plurality of spectral signatures;
determining heights of data points in the scene above a baseline height and matching the determined heights to one of a specified plurality of object height patterns; or
generating the point cloud representing the scene from two-dimensional imagery of the scene, the two-dimensional imagery including a two-dimensional multispectral image of an overhead view of the scene.

6. The system of claim 1, wherein the at least one electromagnetic propagation parameter comprises at least one of a reflectivity, a transmittivity, an absorptivity, a frequency-dependent value of reflectivity, a frequency-dependent value of transmittivity, or a frequency-dependent value of absorptivity.

7. The system of claim 1, wherein the plurality of element types includes at least one of a building, a tree, bare earth, low-lying vegetation, a sidewalk, a road, a parking lot, water, or a miscellaneous man-made structure.

8. The system of claim 7, wherein:
a first element type of the plurality of element types is a building formed from at least a first building material and a second building material; and
the at least one electromagnetic propagation parameter corresponding to the building includes at least one first value corresponding to a first building material, and at least one second value corresponding to a second building material different from the first building material.

9. The system of claim 1, where using the raytracing model to simulate electromagnetic radiation comprises:
incorporating the surface mesh representation into the raytracing model; and
tracing rays, using the raytracing model, that propagate away from the at least one electromagnetic radiation source, such that at least some of the rays interact with the surface mesh representation of the first scene element.

10. The system of claim 1, wherein the operations further comprise:
segmenting the point cloud into a plurality of scene elements, the plurality of scene elements including the first scene element, the plurality of scene elements fully representing elements identified in the point cloud;
assigning at least one electromagnetic propagation parameter to each scene element;
creating a surface mesh representation of the plurality of scene elements;
incorporating the surface mesh representation into the raytracing model; and
tracing rays, using the raytracing model, that propagate away from the at least one electromagnetic radiation source, such that at least some of the rays interact with the surface mesh representation of the plurality of scene elements.

11. The system of claim 1, wherein calculating the spatially-varying radiation level within the scene comprises calculating, for each volume element in the raytracing model, a value of one of electromagnetic power, electromagnetic energy, electromagnetic power density, or electromagnetic energy density.

12. The system of claim 1, wherein augmenting the point cloud with data corresponding to the calculated spatially-varying radiation level comprises storing the data in a data store.

13. A method, comprising:
identifying, from a three-dimensional point cloud representing a scene, at least a first scene element that has a first element type selected from a plurality of element types;
assigning to the first scene element, based on the first element type, at least one electromagnetic propagation parameter that is configured to quantify how the first scene element interacts with electromagnetic radiation;
creating a surface mesh representation of the first scene element;
using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with the first scene element;
calculating, from the simulation, a spatially-varying radiation level within the scene; and
augmenting the point cloud with data corresponding to the calculated spatially-varying radiation level.

14. The method of claim 13, further comprising displaying a visualization of the point cloud augmented with the data corresponding to the calculated radiation level.

15. The method of claim 14, further comprising displaying an indication of volumes in which the calculated radiation level falls below a threshold radiation level.

16. A non-transitory machine-readable medium storing instructions which, when executed by a computing machine, cause the computing machine to perform operations, the operations comprising:
identifying, from a three-dimensional point cloud representing a scene, at least a first scene element that has a first element type selected from a plurality of element types;
assigning to the first scene element, based on the first element type, at least one electromagnetic propagation parameter that is configured to quantify how the first scene element interacts with electromagnetic radiation;
creating a surface mesh representation of the first scene element;
using a raytracing model to simulate electromagnetic radiation radiating from at least one electromagnetic radiation source positioned in the scene, the raytracing model incorporating data from the surface mesh representation and the at least one electromagnetic radiation source, the radiating comprising at least one interaction with the first scene element;
calculating, from the simulation, a spatially-varying radiation level within the scene; and
augmenting the point cloud with data corresponding to the calculated spatially-varying radiation level.

17. The non-transitory machine-readable medium of claim 16, wherein the operations further comprise generating the three-dimensional point cloud of the scene based on at least one of:
using a beam of coherent light, via laser detector and ranging (LADAR) or light detection and ranging (LiDAR), to measure distances to elements in the scene, the elements including the first scene element;
using a radio-frequency emission, via synthetic aperture radar (SAR), to measure distances to elements in the scene, the elements including the first scene element; or
using multiple optical images, via photogrammetric extraction, to perform multi-image matching of comparable points in two or more images of the multiple optical images.

18. The non-transitory machine-readable medium of claim 16, wherein identifying, from the point cloud, at least the first scene element comprises at least one of:
determining a spectral content of each data point in the scene and matching the determined spectral content to one of a specified plurality of spectral signatures;
determining heights of data points in the scene above a baseline height and matching the determined heights to one of a specified plurality of object height patterns; or
generating the point cloud representing the scene from two-dimensional imagery of the scene, the two-dimensional imagery including a two-dimensional multispectral image of an overhead view of the scene.

19. The non-transitory machine-readable medium of claim 16, where using the raytracing model to simulate electromagnetic radiation comprises:
incorporating the surface mesh representation into the raytracing model; and
tracing rays, using the raytracing model, that propagate away from the at least one electromagnetic radiation source, such that at least some of the rays interact with the surface mesh representation of the first scene element.

20. The non-transitory machine-readable medium of claim 16, wherein the operations further comprise:
segmenting the point cloud into a plurality of scene elements, the plurality of scene elements including the first scene element, the plurality of scene elements fully representing elements identified in the point cloud;
assigning at least one electromagnetic propagation parameter to each scene element;
creating a surface mesh representation of the plurality of scene elements;
incorporating the surface mesh representation into the raytracing model; and
tracing rays, using the raytracing model, that propagate away from the at least one electromagnetic radiation source, such that at least some of the rays interact with the surface mesh representation of the plurality of scene elements.
